(19) United States
(12) Patent Application Publication
(10) Pub. No.: US 2026/0057598 A1
(43) Pub. Date: Feb. 26, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Keigo YONEDA, Kanagawa (JP)

(21) Appl. No.: 19/293,045

(22) Filed: Aug. 7, 2025

(30) Foreign Application Priority Data
Aug. 20, 2024 (JP) 2024-139224

(51) Int. Cl. G06T 15/04; G06T 7/70

(52) U.S. Cl. CPC G06T 15/04; G06T 7/70

(57) ABSTRACT

An image processing apparatus according to the present disclosure that generates a VR image that allows a direction image to be generated in which an image corresponding to an object present at a position far from a base point may be represented in high definition obtains an object model that is generated on the basis of a plurality of captured images obtained through imaging from a plurality of positions and indicates a three-dimensional shape of an object present in an imaging region, determines a position of a virtual object in a virtual space, obtains texture of the virtual object, sets a position of the base point in the virtual space, and generates a VR image corresponding to the base point on the basis of the position of the base point, the object model, the virtual object, and the texture of the virtual object.

### BACKGROUND

### Field of the Technology

The present disclosure relates to image processing technology that generates a VR (Virtual Reality) image on the basis of a plurality of captured images obtained through imaging from a plurality of positions.

### Description of the Related Art

There is technology that generates an image (referred to as “virtual viewpoint image” below) corresponding to a view from any virtual viewpoint (referred to as “virtual viewpoint” below) using a plurality of captured images obtained through imaging by a plurality of imaging devices in synchronization with each other. The plurality of imaging devices is disposed at positions different from each other. The following refers to the plurality of captured images described above as “multi-viewpoint images” for description. In addition, there is technology that generates or obtains an image corresponding to a view in any direction from a predetermined position (“base point” below) by clipping a partial image region from a panoramic image, an omnidirectional image, or the like corresponding to the surrounding view within a maximum range of 360 degrees from the base point. The following refers to the image as a “direction image” for description.

Japanese Patent Laid-Open No. 2020-68513 (referred to as “Patent Literature 1” below) discloses technology that generates an image such as a panoramic image or an omnidirectional image corresponding to a base point by combining a plurality of virtual viewpoint images. Specifically, the technology disclosed in Patent Literature 1 generates, using multi-viewpoint images, virtual viewpoint images corresponding to a plurality of respective virtual viewpoints that is set at the same position and has viewing directions different from each other, and combines the plurality of generated virtual viewpoint images. In addition, Patent Literature 1 discloses technology that distributes an image generated by combining the virtual viewpoint images and corresponding to the base point to a user terminal, and generates, using the image corresponding to the base point, a direction image corresponding to a direction designated by a user in the user terminal.

### SUMMARY

The inventor has found that a representation of an object present at a position farther from the base point is reduced more in resolution in the direction image generated by the technology disclosed in Patent Literature 1 and it is therefore difficult to visually recognize the object with high accuracy in the displayed direction image in some cases. For example, in a case where the imaging subject is a game at the ballpark and the position of a base point is located near the catcher, a representation of the scoreboard disposed above the centerfield screen is low in resolution in a direction image corresponding to the direction from the base point to the pitcher.

According to an aspect of the present disclosure, there is provided technology that generates a VR image which allows a direction image to be generated. The direction image may represent, in high definition, an image corresponding to an object present at a position far from a base point.

An image processing apparatus according to the present disclosure includes: one or more hardware processors; and one or more memories storing one or more programs configured to be executed by the one or more hardware processors, the one or more programs including instructions for: obtaining an object model that is generated on the basis of a plurality of captured images obtained through imaging from a plurality of positions, the object model indicating a three-dimensional shape of an object present in an imaging region: determining a position of a virtual object in a virtual space: obtaining texture of the virtual object; setting a position of a base point in the virtual space; and generating a VR image corresponding to the base point on the basis of the position of the base point, the object model, the virtual object, and the texture of the virtual object.

Features of the present disclosure will become apparent from the following description of embodiments with reference to the attached drawings. The following description of embodiments are described by way of example.

### BRIEF DESCRIPTION OF THE DRAWINGS

FIGS. 1A and 1B are figures each for describing an example of a configuration of an image processing system according to an embodiment 1;

FIG. 2 is a block diagram illustrating an example of a hardware configuration of an image processing apparatus according to the embodiment 1;

FIG. 3 is a block diagram illustrating an example of a functional configuration of the image processing apparatus according to the embodiment 1;

FIG. 4 is a figure for describing an example of a generation process of a virtual object by a virtual object generating unit according to the embodiment 1;

FIG. 5 is a figure illustrating an example of a VR image generated by an image generating unit according to the embodiment 1;

FIG. 6 is a flowchart illustrating an example of a flow of a process by the image processing apparatus according to the embodiment 1; and

FIG. 7 is a flowchart illustrating an example of a flow of the generation process of the virtual object by the virtual object generating unit according to the embodiment 1.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. Incidentally, an identical reference numeral is assigned to an identical constituent and an explanation thereof is made.

It is to be noted that a virtual viewpoint image is an image generated on the basis of the position and the orientation of a virtual imaging device (referred to as “virtual camera” below) which is defined by at least the position of a virtual viewpoint and a viewing direction at the virtual viewpoint in the following embodiment. The virtual viewpoint image is also referred to as free-viewpoint image, arbitrary-viewpoint image, or the like.

In addition, the VR image is an image that may be subjected to VR display as described below. The VR image includes an omnidirectional image, a panoramic image having a wider video image range (effective video image range) than a display range that may be displayed by a display unit at one time, and the like. In addition, the VR image is not limited to a still image and includes a moving image. The VR image has a maximum video image range (effective video image range) corresponding to a visual field of 360 degrees in the left-right direction and 360 degrees in the up-down direction. In addition, the VR image also includes an image having a wider angle of view than an angle of view that may be imaged by a normal imaging device or a wider video image range than the display range that may be displayed by the display unit at one time in spite of a video image range (effective video image range) corresponding to a visual field of less than 360 degrees in the left-right direction and less than 360 degrees in the up-down direction. For example, setting the display mode of a display apparatus (a display apparatus capable of displaying the VR image) to “VR view” allows the VR image to be subjected to VR display. Displaying a partial range of a VR image having an angle of view of 360 degrees and a user changing the orientation of the display apparatus in the left-right direction (horizontal rotation direction) move the displayed range and allow an omnidirectional video image to be watched that is seamless in the left-right direction.

Here, the VR display (VR view) is a display method (display mode) that allows the display range to be changed within which a video image of a VR image within a visual field boundary corresponding to the orientation of the display apparatus is displayed. The VR display includes “monocular VR display (monocular VR view)” that performs transformation (transformation in which distortion correction is applied) of mapping a VR image to a virtual sphere and displays one image. In addition, the VR display includes “binocular VR display (binocular VR view)” that performs transformation of mapping a VR image for a left eye and a VR image for a right eye to respective virtual spheres and displays the VR images in the left and right regions side by side. The “binocular VR display” is performed using the VR image for a left eye and the VR image for a right eye having parallax in between, thereby allowing for stereoscopic vision.

Any of the VR displays displays a video image within the visual field boundary corresponding to the direction of the face of a user, for example, in a case where the user wears a display apparatus such as an HMD (head-mounted display). For example, it is assumed that a video image of a VR image within the visual field boundary having the center at 0 degrees (a specific azimuth, for example, the north) in the left-right direction and at 90 degrees (90 degrees from the zenith, that is, the horizon) in the up-down direction at a certain time point is displayed. In a case where the front and back of the display apparatus are inverted as the orientation thereof from this state (e.g., the display surface is changed to face the north from the south), the display range is changed to a video image of the same VR image within the visual field boundary having the center at 180 degrees (the opposite azimuth, for example, the south) in the left-right direction and at 90 degrees in the up-down direction. That is, the user faces the south from the north (i.e., turns around) in a state in which the user is wearing an HMD, and this also changes the video image displayed on the HMD from a north video image to a south video image.

### Embodiment 1

In the present embodiment, an aspect will be described in which a virtual object that represents a real object is disposed near a base point in a virtual three-dimensional space (referred to simply as “virtual space” below) using multi-viewpoint images and a VR image corresponding to the base point is generated. Here, the real object is an object that is physically present. In addition, the virtual object is an object model corresponding to a virtual object that is generated using CG (computer graphics) technology or the like and is not physically present.

### <Configuration of Image Processing System>

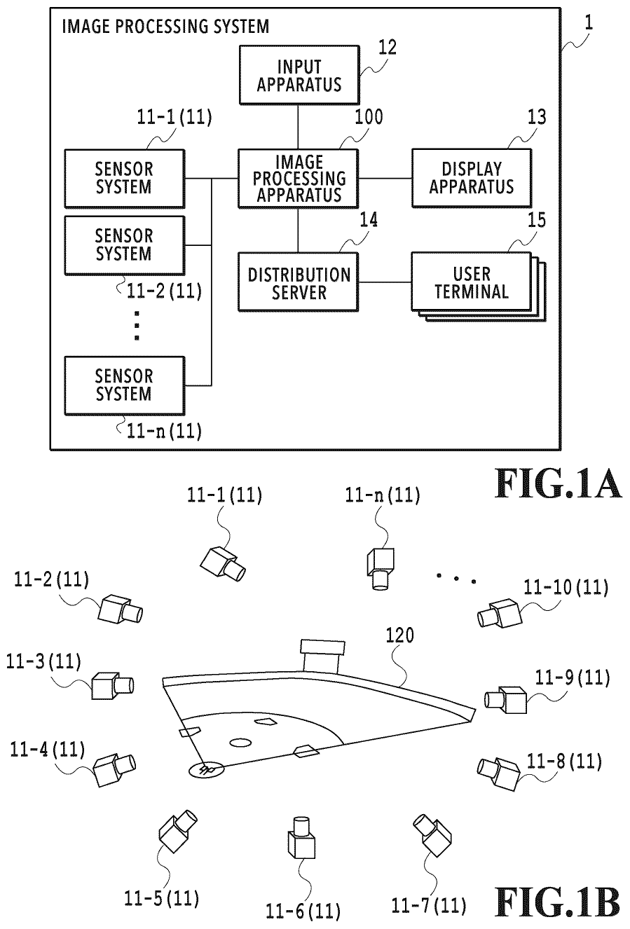

FIGS. 1A and B are figures each for describing an example of the configuration of an image processing system 1 according to an embodiment 1. Specifically, FIG. 1A is a block diagram illustrating an example of the configuration of the image processing system 1. The image processing system 1 includes an image processing apparatus 100, a plurality of sensor systems 11-1 to 11-n (n is an integer of 2 or more), an input apparatus 12, a display apparatus 13, a distribution server 14, and one or more user terminals 15. In particular, in a case where there is no need to distinguish the sensor systems 11-1 to 11-n for description, the following gives description by referring to the sensor systems 11-1 to 11-n as the sensor systems 11 without distinguishing the sensor systems 11-1 to 11-n.

Each of the sensor systems 11 includes one or more imaging devices. The imaging devices each include a digital still camera, a digital video camera, or the like. Captured images (multi-viewpoint images) obtained through imaging by the imaging devices included in the respective sensor systems 11 are transmitted to the image processing apparatus 100 and the image processing apparatus 100 obtains these captured images (multi-viewpoint images). Specifically, the plurality of imaging devices included in the plurality of sensor systems 11 is disposed at positions different from each other and performs imaging in synchronization with each other. It is to be noted that a plurality of images included in the multi-viewpoint images may be captured images themselves that are obtained through imaging by the respective imaging devices or images obtained by performing image processing such as a process of extracting predetermined regions from the captured images. The multi-viewpoint images obtained through imaging by the plurality of imaging devices included in the plurality of sensor systems 11 in synchronization are transmitted to the image processing apparatus 100 along with the imaging parameters of the respective imaging devices included in the plurality of sensor systems 11.

The imaging parameters include data such as an extrinsic parameter, an intrinsic parameter, and the image size of a captured image obtained through imaging. The extrinsic parameter is a parameter indicating the position and the orientation of an imaging device and includes parameters represented by a rotation matrix, a position vector, and the like. The intrinsic parameter is a parameter indicating information specific to an imaging device and includes parameters indicating focal length, the position of the middle of a captured image, the distortion of an optical system such as a lens, and the like. The image size is represented by the number of pixels or the like in the transverse direction and the height direction of a captured image. FIG. 1B is a figure illustrating an example of the disposition of the plurality of sensor systems 11. The plurality of sensor systems 11 is disposed to surround an imaging region 120. The following gives description on the assumption that the imaging region 120 is a ballpark at which a baseball game is played and the plurality of sensor systems 11 such as the 100 sensor systems 11 is disposed to surround the ballpark. Needless to say, the imaging region 120 is not limited to the ballpark. For example, the imaging region 120 may be an indoor court or the like at which a basketball game is played.

The image processing apparatus 100 includes a personal computer, a server apparatus, or the like and generates a VR image such as an omnidirectional image or a panoramic image using obtained multi-viewpoint images. Specifically, the image processing apparatus 100 first generates an object model using the obtained multi-viewpoint images. The object model indicates the three-dimensional shape of a real object present in the imaging region 120. The following assumes that the object model generated by the image processing apparatus 100 includes information indicating the shape of the object and information indicating the color of the shape. The object model generated by the image processing apparatus 100 and corresponding to the real object is stored in a database not illustrated in FIGS. 1A and B in association with a time code used when the multi-viewpoint images are captured.

The time code is information that may uniquely identify the time when an imaging device obtains a captured image (a frame in a case where the captured image is a movie). The information is represented, for example, in a format such as “day: hour: minute: second, frame number”. Subsequently, the image processing apparatus 100 disposes a virtual object in a virtual space corresponding to the imaging region 120. The virtual object is not present in the imaging region 120. Subsequently, the image processing apparatus 100 draws (also referred to as “renders”) the virtual object and the generated object model corresponding to the real object together to generate a VR image such as a panoramic image. The generated VR image is output to the distribution server 14 and distributed to the user terminals 15 through the distribution server 14.

More specifically, the image processing apparatus 100 first obtains multi-viewpoint images and the imaging parameters of the respective imaging devices. Subsequently, the image processing apparatus 100 generates shape information indicating the three-dimensional shape of an object (referred to as “foreground object” below) serving as foreground and color information (also referred to as “texture information”) about the three-dimensional shape on the basis of the obtained multi-viewpoint images and imaging parameters. It is to be noted that the shape information is also referred to as “geometry information”. Examples of the foreground object include moving objects such as a natural person and a ball present in the imaging region 120. For example, a Visual Hull technique is used to generate the shape information about the foreground object. For example, in a case where the shape information is generated using the Visual Hull technique, the shape information is obtained as a three-dimensional point cloud that is a set of points represented using three-dimensional coordinates. It is to be noted that the method for generating the shape information about the foreground object using captured images is not limited to the Visual Hull technique. In addition, the method for representing the shape information about the foreground object is not limited to the three-dimensional point cloud and the shape information may be represented using a polygon mesh, a voxel, or the like.

The color information about the foreground object is generated in a method as described below. For example, the image processing apparatus 100 uses any point in the three-dimensional point cloud as a point of interest and uses the color value of a projection destination pixel as the color value of the point of interest in a case where the point is projected on a captured image obtained through imaging by an imaging device capable of imaging the point in the imaging region 120 corresponding to the point of interest. The image processing apparatus 100 performs such a process sequentially using all the points or some of the points included in the three-dimensional point cloud as points of interest, thereby generating the color information about the foreground object. It is to be noted that the method for generating the color information about the foreground object is not limited to the method described above. The foreground object is rendered by projecting each of the points in the three-dimensional point cloud on the image sensing surface of a virtual camera.

Subsequently, the image processing apparatus 100 generates color information (texture information) about an object (referred to as “background object” below) serving as background on the basis of the multi-viewpoint images, the imaging parameters, and shape information about the background object. In a case where the imaging subject is a game at the ballpark, the background object includes objects such as a fence, the centerfield screen, the scoreboard, a billboard, the stands at which the audience seats and the like are disposed, and the field included in the ballpark other than foreground objects. In addition, the shape information about the background object is information indicating the three-dimensional shape of the background object.

For example, the shape information about the background object is created and stored in a storage device in advance. The image processing apparatus 100 obtains the shape information by reading out the shape information from the storage device and generates color information corresponding to the obtained shape information about the background object. It is to be noted that the shape information about the background object may be obtained by the image processing apparatus 100 generating the shape information about the background object on the basis of the multi-viewpoint images, the imaging parameters, and the like. The following gives description on the assumption that the shape information about the background object is data represented using a polygon mesh and the color information is data represented using a texture image.

The texture image is an image to be subjected to UV mapping to the three-dimensional shape of the background object indicated by the shape information about the background object. The texture image is generated in a method as described below. For example, in a case where the respective vertexes of a plurality of polygons included in a polygon mesh corresponding to the background object are projected on respective captured images, the image processing apparatus 100 first clips image regions including pixels corresponding to the respective vertexes as partial images. Specifically, in a case where the respective vertexes of the plurality of polygons are projected on captured images obtained through imaging by imaging devices each capable of imaging at least part of the background object, the image processing apparatus 100 clips image regions including pixels corresponding to the respective vertexes as partial images. Subsequently, the image processing apparatus 100 generates a texture image by joining the plurality of partial images clipped from the respective captured images. It is to be noted that the method for generating the color information about the background object is not limited to the method described above.

The background object is rendered by virtually imaging a background object model with a virtual camera. The background object model is obtained by subjecting the texture image to UV mapping to a polygon mesh corresponding to the background object and corresponds to the background object. The image processing apparatus 100 disposes the virtual object in a virtual space. Details of the method for disposing the virtual object will be described below. A position at which the virtual object is disposed is determined, for example, on the basis of a user operation on the input apparatus 12 described below.

Subsequently, the image processing apparatus 100 performs rendering such that the object model corresponding to the real object and the virtual object are included within the angle of view of a virtual camera virtually disposed at a base point, thereby generating a VR image. Specifically, the VR image generated by the image processing apparatus 100 is an image obtained by virtually imaging the entire circumference of the base point set in the virtual space from the base point with a virtual camera. The position of the base point is determined, for example, on the basis of a user operation on the input apparatus 12 described below. Specifically, for example, the VR image may be in any format as long as the format is a format requested by the distribution server 14. Examples of the format include an equidistant cylindrical projection, a cubemap, and the like. The VR image generated by the image processing apparatus 100 is output to the distribution server 14.

The input apparatus 12 receives an operation made by a user (referred to as “operator” below) of the image processing apparatus 100 and transmits a signal corresponding to the operation to the image processing apparatus 100. Specifically, for example, the operator makes inputs of designating the position of the base point of the VR image and the position at which the virtual object is disposed by operating the input apparatus 12. The input apparatus 12 transmits signals corresponding to the inputs to the image processing apparatus 100. The image processing apparatus 100 determines the position of the base point of the VR image and the position at which the virtual object is disposed on the basis of the signals received from the input apparatus 12, and sets the base point of the VR image and disposes the virtual object. The input apparatus 12 includes an input unit such as a joy stick, a touch panel, a keyboard, or a mouse, or an input unit including two or more of them. The operator inputs the position of the base point of the VR image and the position at which the virtual object is disposed by operating the input unit. The position of the base point and the position at which the virtual object is disposed are designated using, for example, three-dimensional coordinates in the virtual space.

As an example, the following gives description on the assumption that the input apparatus 12 includes a keyboard as the input unit and the operator inputs, using the keyboard, the three-dimensional coordinate values of the position of the base point and the position at which the virtual object is disposed. In addition, description will be given on the assumption that the values of the respective components (x, y, z) of a three-dimensional coordinate system set in advance in the virtual space are input as the three-dimensional coordinate values. It is to be noted that the determination by the image processing apparatus 100 about the position of the base point of the VR image and the position at which the virtual object is disposed is not limited to a method based on inputs made by the operator through the input apparatus 12. For example, the image processing apparatus 100 may read out a file or the like in which the three-dimensional coordinate values corresponding to the position of the base point of the VR image and the position at which the virtual object is disposed are set and stored in advance from the storage device and make the determination.

The display apparatus 13 includes a liquid crystal display or the like and displays a VR image generated by the image processing apparatus 100, an operation GUI (graphical user interface), and the like as information necessary for an operator to perform an operation. The operator watches the VR image displayed on the display apparatus 13 and inputs the position of the base point, the position at which the virtual object is disposed, and the like through the input apparatus 12. For example, in a case where the imaging subject is a game at the ballpark, the operator inputs the coordinates of a position in the virtual space corresponding to the position at which the pitcher is present or a nearby position, the position at which the catcher is present or a nearby position, or the like through the input apparatus 12. The distribution server 14 includes a personal computer or a server apparatus, obtains a VR image output from the image processing apparatus 100, and distributes the VR image to the one or more user terminals 15.

The user terminals 15 each include a personal computer, a smartphone, a tablet terminal, an HMD, or the like and each generate an image corresponding to any viewing direction from the VR image received from the distribution server 14. In addition, the user terminal 15 causes a display device included in the user terminal 15 or a display device connected to the user terminal 15 to display the generated image. That is, the image that the user terminal 15 causes the display device to display is a partial image region in the VR image. A user (referred to simply as “user” below) of the user terminal 15 designates any position in the VR image using a direction from the base point and allows the display device to display the image region in the VR image corresponding to the position as the image. That is, the respective user terminals 15 designate any directions different from each other and allow the respective display devices to display the partial image regions in the VR image.

In a case where each of the user terminals 15 is a portable type or wearing type apparatus such as a smartphone, a tablet terminal, or an HMD, the user terminal 15 may detect a change in the direction of the display surface of the display device using, for example, a gyroscopic sensor, a geomagnetic sensor, or the like included in the user terminal 15. In this case, the user terminal 15 may change the direction from the base point, that is, an image region in the VR image that the display device is caused to display in accordance with the amount of detected change in the direction. It is to be noted that the designation of the direction from the base point is not limited to the gyroscopic sensor or the like described above. The direction from the base point may be designated by the user operating the input device included in the user terminal 15 or the input device connected to the user terminal.

### <Hardware Configuration of Image Processing Apparatus>

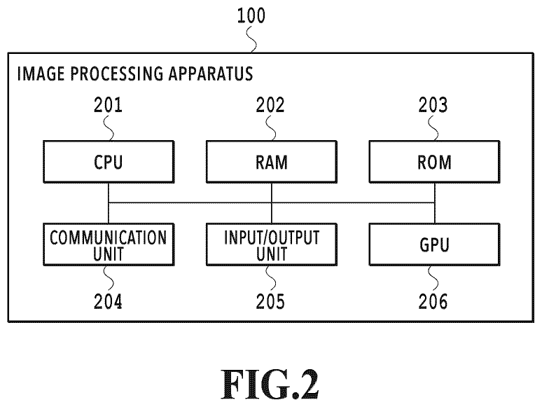

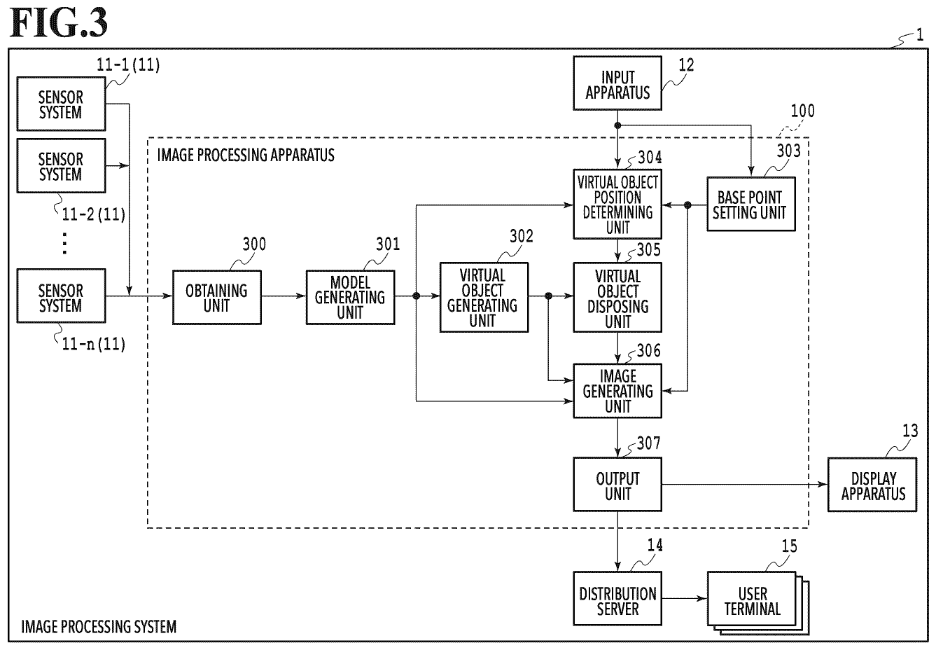

The hardware configuration of the image processing apparatus 100 will be described using FIG. 2. FIG. 2 is a block diagram illustrating an example of the hardware configuration of the image processing apparatus 100 according to the embodiment 1. The image processing apparatus 100 includes a CPU 201, a RAM 202, a ROM 203, a communication unit 204, an input/output unit 205, and a GPU 206 as the hardware configuration. The CPU 201 is a processor that executes a program stored in the ROM 203 using the RAM 202 as a work memory and integrally controls the respective units included in the image processing apparatus 100. The CPU 201 executes various programs, thereby achieving functions of the respective units included in the image processing apparatus 100 as the functional configuration illustrated in FIG. 3 described below. The RAM 202 temporarily stores a computer program read out from the ROM 203 and data such as a result obtained in the middle of calculation. The ROM 203 holds a computer program and data that do not need changing. The following gives description on the assumption that the ROM 203 holds shape information about a background object.

The communication unit 204 is a communication interface such as Ethernet® or a USB and is used for data communication with an external apparatus. The communication unit 204 transmits a VR image to the distribution server 14, for example, through Ethernet. The input/output unit 205 inputs/outputs data through an input interface and an output interface. The input/output unit 205 receives, for example, signals related to the position of a base point of the VR image and a position at which a virtual object is disposed from the input apparatus 12. In addition, the input/output unit 205 outputs, for example, signals related to a VR image, an operation GUI, and the like to the display apparatus 13. The GPU 206 is a calculator or a processor specialized in image processing. The GPU 206 performs image processing of generating a virtual viewpoint image, a VR image, or the like from multi-viewpoint images input from the plurality of sensor systems 11.

### <Functional Configuration of Image Processing Apparatus>

FIG. 3 is a block diagram illustrating an example of the functional configuration of the image processing apparatus 100 according to the embodiment 1. The image processing apparatus 100 includes an obtaining unit 300, a model generating unit 301, a virtual object generating unit 302, a base point setting unit 303, a virtual object position determining unit 304, a virtual object disposing unit 305, an image generating unit 306, and an output unit 307 as the functional configuration. Each of the units included in the image processing apparatus 100 as the functional configuration is achieved by the CPU 201 executing a program stored in the ROM 203 using the RAM 202 as a work memory. The obtaining unit 300 obtains multi-viewpoint images output from the plurality of sensor systems 11 and the imaging parameters of the imaging devices included in the respective sensor systems 11 through the communication unit 204. The multi-viewpoint images and the imaging parameters obtained by the obtaining unit 300 are stored in the RAM 202 and used for processes by the model generating unit 301, the virtual object generating unit 302, the image generating unit 306, and the like.

The model generating unit 301 generates an object model corresponding to a foreground object and an object model (background object model) corresponding to a background object. Specifically, the model generating unit 301 generates the object model corresponding to the foreground object using the multi-viewpoint images and the imaging parameters obtained by the obtaining unit 300. The method for generating the object model corresponding to the foreground object has been described above and description thereof will be thus omitted.

In addition, the model generating unit 301 generates the background object model using the shape information about the background object stored in the ROM 203 and the multi-viewpoint images and the imaging parameters obtained by the obtaining unit 300. Specifically, the model generating unit 301 first generates a texture image to be subjected to UV mapping to a polygon mesh corresponding to the background object using the shape information, the multi-viewpoint images, and the imaging parameters. Subsequently, the model generating unit 301 subjects the generated texture image to UV mapping. The background object model is generated by UV mapping to the polygon mesh corresponding to the background object. The method for generating the texture image to be subjected to UV mapping to the polygon mesh has been described above and description thereof will be thus omitted. The object model generated by the model generating unit 301 and corresponding to the foreground object and the background object model generated by the model generating unit 301 and corresponding to the background object are stored in the RAM 202 and used for processes by the virtual object generating unit 302, the image generating unit 306, and the like.

The base point setting unit 303 sets a base point of a VR image. Specifically, for example, on the basis of a signal related to the position of the base point of the VR image output from the input apparatus 12 or information related to the position stored in advance in the ROM 203 or the like, the base point setting unit 303 determines the base point of the VR image at the position in a virtual space. Information about the three-dimensional coordinate value or the like of the position in the virtual space related to the position of the base point of the VR image determined by the base point setting unit 303 is stored in the RAM 202 as a setting value related to the position of the base point.

The virtual object position determining unit 304 determines a position at which a virtual object is disposed in the virtual space. Specifically, for example, the virtual object position determining unit 304 determines the position at which the virtual object is disposed on the basis of a signal related to the position at which the virtual object is disposed and output from the input apparatus 12 or information related to the position stored in advance in the ROM 203 or the like. The method for determining the position at which the virtual object is disposed is not limited to this and the virtual object position determining unit 304 may determine the position at which the virtual object is disposed, for example, on the basis of the position of the base point of the VR image set by the base point setting unit 303. Specifically, for example, the virtual object position determining unit 304 determines a position near the base point of the VR image as the position at which the virtual object is disposed.

In addition, for example, the position at which the virtual object is disposed may be determined on the basis of the position of the base point of the VR image set by the base point setting unit 303 and the position of the object model generated by the model generating unit 301 and corresponding to the foreground object. Specifically, for example, the virtual object position determining unit 304 determines the position at which the virtual object is disposed on the basis of the positional relationship between the position of the base point of the VR image and the position of the object model corresponding to the foreground object. More specifically, for example, the virtual object position determining unit 304 determines, as the position at which the virtual object is disposed, a position at which the virtual object does not occlude the object model in a case where the object model is viewed from the base point of the VR image. Information such as the three-dimensional coordinate value of the position in the virtual space related to the position at which the virtual object is disposed that is determined by the virtual object position determining unit 304 is stored in the RAM 202.

The virtual object generating unit 302 generates a virtual object. Details of a generation process of the virtual object by the virtual object generating unit 302 will be described below. The virtual object generated by the virtual object generating unit 302 is stored in the RAM 202. The virtual object disposing unit 305 disposes the virtual object at the position determined by the virtual object position determining unit 304.

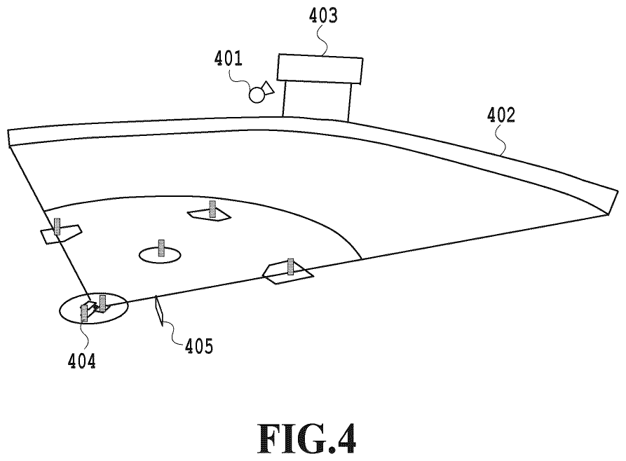

The generation process of the virtual object will be described. For example, in a case where the imaging subject is a game at the ballpark, the virtual object is, for example, a panel-shaped virtual object that represents the scoreboard or the like disposed above the centerfield screen. Shape information indicating the three-dimensional shape of the virtual object is, for example, prepared in advance and stored in the ROM 203 or the like. The virtual object generating unit 302 uses, as a texture image, a virtual viewpoint image obtained by virtually imaging a background object model or the like with a virtual camera and pastes the texture image to a panel-shaped polygon mesh prepared in advance, thereby generating a virtual object. Here, the virtual camera described above is a virtual camera different from a virtual camera used to generate a VR image. The virtual camera described above images an object model corresponding to a real object of interest such as the scoreboard at high resolution. A more detailed method for generating the virtual object will be described below using FIG. 4.

The virtual object generated in this way is disposed at a position near a base point of a VR image, which may expect the following effects. Specifically, a representation of a real object present far from the position corresponding to the base point in the imaging region 120 may appear large in a VR image. The representation of the real object has conventionally appeared small and been low in resolution and difficult to visually recognize in a VR image. As a result, the representation of the real object may be clearly displayed or displayed to be visually recognizable to a user on the display device of the user terminal 15.

It is to be noted that description has been given in the present embodiment on the assumption that the virtual object generating unit 302 uses a virtual viewpoint image as a texture image to be pasted to a panel-shaped polygon mesh as described above. This is not, however, limitative. For example, the virtual object generating unit 302 may use, as the texture image, an image obtained by clipping an image region including a representation of an object of interest such as a scoreboard from a texture image to be subjected to UV mapping to the shape of a real object such as a background object. In addition, for example, the virtual object generating unit 302 may use, as the texture image, each of images obtained by clipping image regions each including a representation of an object of interest such as a scoreboard from captured images included in multi-viewpoint images obtained by the obtaining unit 300.

In addition, in the present embodiment, description will be given on the assumption that a virtual object has a panel shape as described above, but the shape of the virtual object is not limited to this. For example, the virtual object generating unit 302 may clip shape information indicating the three-dimensional shape of a background object of interest such as a scoreboard present in a distance from the shape information about the background object and use the shape information as shape information about a virtual object. This allows the shape of the virtual object to be the identical or substantially identical shape to the shape of the background object of interest such as a scoreboard.

The image generating unit 306 generates a VR image. Specifically, the image generating unit 306 generates a VR image corresponding to the appearance of object models corresponding to a foreground object and a background object and a virtual object from a base point in a virtual space. The method for generating the VR image has been described above and description thereof will be thus omitted. The VR image generated by the image generating unit 306 is stored in the RAM 202. The output unit 307 outputs the VR image generated by the image generating unit 306 to the distribution server 14 through the communication unit 204.

### <Generation Process of Virtual Object>

The generation process of the virtual object will be described with reference to FIG. 4. FIG. 4 is a figure for describing an example of the generation process of the virtual object by the virtual object generating unit 302 according to the embodiment 1. FIG. 4 illustrates an overview of an imaging subject as viewed from a distance in a case where the imaging subject is a game at the ballpark as an example. In FIG. 4, a region illustrated as a gray rectangle represents a player playing the game. In FIG. 4, an object 403 is a scoreboard disposed above a centerfield screen that is a background object and a portion of a ballpark 402. The object 403 is a real object of interest in the present embodiment that corresponds to a virtual object. That is, the virtual object has, for example, a panel shape that represents the shape of the object 403.

An imaging device 401 illustrated in FIG. 4 indicates a virtual imaging device, that is, the position and the orientation of a virtual camera in a virtual space. The imaging device 401 is not really present in the imaging region 120. A position 404 is a position corresponding to the position of a base point set in the virtual space by the base point setting unit 303. A virtual object 405 indicates the shape and the position of a virtual object disposed in the virtual space by the virtual object disposing unit 305 and is not really present in the imaging region 120. The imaging device 401 that is a virtual camera generates a virtual viewpoint image corresponding to a representation of the object 403 by virtually imaging an object model corresponding to the object 403 in the virtual space. The virtual object generating unit 302 pastes the generated virtual viewpoint image to the panel-shaped virtual object 405 as a texture image, thereby generating the virtual object 405. The generated virtual object is disposed at a position in the virtual space corresponding to a position near the position 404 set as a base point at which the catcher at the ballpark 402 is present.

### <Generation Example of VR Image>

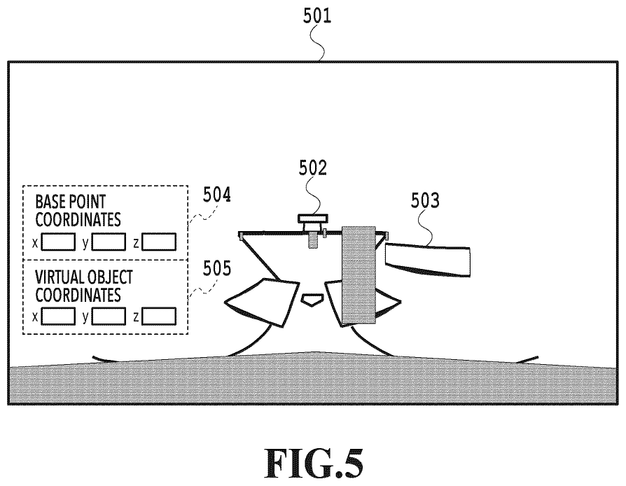

FIG. 5 is a figure illustrating an example of a VR image 501 generated by the image generating unit 306 according to the embodiment 1. The VR image 501 includes a representation 502 of the object 403 and a representation 503 of the virtual object 405 and the VR image 501 is displayed on the display apparatus 13. The image processing apparatus 100 displays a base point position designating region 504 and a virtual object position designating region 505 by superimposing the base point position designating region 504 and the virtual object position designating region 505 on the VR image 501. The base point position designating region 504 is used for an operator to input the three-dimensional coordinate value of the base point. The virtual object position designating region 505 is used for the operator to input a three-dimensional coordinate value for disposing the virtual object. The operator inputs the three-dimensional coordinate values to the base point position designating region 504 and the virtual object position designating region 505 using the input apparatus 12. The image processing apparatus 100 receives signals based on the inputs, sets the base point of the VR image, and determines a position at which the virtual object is disposed.

A background object model corresponding to the object 403 is present at a position far from the position 404 of the base point in the virtual space. In the VR image, the representation 502 of the object 403 thus grows lower in resolution. That is, in a case where a user sets a viewing direction from the base point to the direction in which the background object model corresponding to the object 403 is located in the user terminal 15, a representation of the object 403 also grows lower in resolution in an image displayed on the display device of the user terminal 15. It is therefore difficult for the user to visually recognize the score of the game included in the image, information about a player, or the like.

Meanwhile, the virtual object 405 to which a virtual viewpoint image obtained by virtually imaging the background object model corresponding to the object 403 with a virtual camera is pasted as a texture image is disposed near the position 404 of the base point. The representation 503 of the virtual object 405 therefore grows larger and higher in resolution in the VR image. That is, a representation of the virtual object 405 also grows higher in resolution in the image displayed on the display device of the user terminal 15. This allows the user to visually recognize the score of the game included in the image, the information about the player, or the like.

The VR image generated by the image processing apparatus 100 is distributed to the plurality of user terminals 15 through the distribution server 14. A user of each of the user terminals 15 designates any viewing direction to select an image region corresponding to the designated viewing direction from the VR image and allows the display device of the user terminal 15 to display the image region. This allows the user of each of the user terminals 15 to learn, for example, in a case where the imaging subject is a game at the ballpark, information beneficial for watching the baseball game presented to the object 403 using the user terminal 15 of the user himself or herself while watching the game.

### <Operation of Image Processing Apparatus>

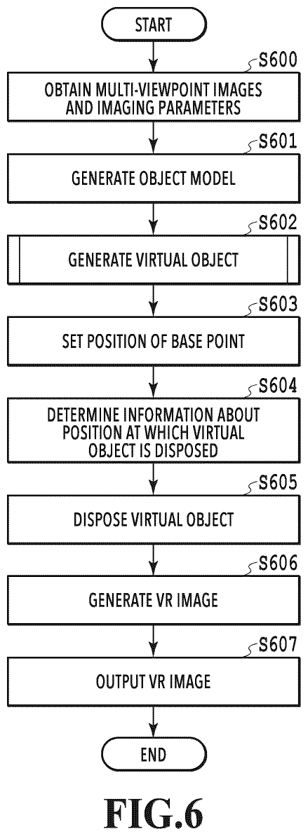

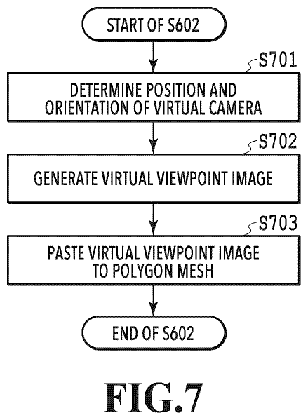

An operation of the image processing apparatus 100 will be described with reference to FIGS. 6 and 7. FIG. 6 is a flowchart illustrating an example of a flow of processes by the image processing apparatus 100 according to the embodiment 1. The processes in the flowchart illustrated in FIG. 6 are achieved by the CPU 201 loading a control program stored in the ROM 203 onto the RAM 202 and executing the control program. It is to be noted that the processes in the flowchart are repetitively executed whenever multi-viewpoint images and imaging parameters are output from the plurality of sensor systems 11. In addition, the following represents each of process steps (processes) by attaching “S” to the head of the reference numeral. First, in S600, the obtaining unit 300 obtains multi-viewpoint images and imaging parameters output from the plurality of sensor systems 11. The obtained multi-viewpoint images and imaging parameters are stored in the RAM 202 and used for processes by the model generating unit 301 and the like.

Next, in S601, the model generating unit 301 generates object models corresponding to a real foreground object and a real background object on the basis of the multi-viewpoint images. The generated object models are stored in the RAM 202 and used for processes by the virtual object generating unit 302, the image generating unit 306, and the like. Next, in S602, the virtual object generating unit 302 generates virtual objects on the basis of the object models generated in S601 and corresponding to the background object and the like. The generated virtual object is stored in the RAM 202 and used for processes by the virtual object disposing unit 305, the image generating unit 306, and the like. Next, in S603, the base point setting unit 303 sets the position of a base point of a VR image on the basis of a signal transmitted from the input apparatus 12. A setting value related to the position of the base point is, for example, a three-dimensional coordinate value in a virtual space that indicates the position of the base point. The setting value that is set and indicates the position of the base point of the VR image is stored in the RAM 202 and used for processes by the image generating unit 306 and the like.

Next, in S604, the virtual object position determining unit 304 determines a position at which the virtual objects generated in S602 are each disposed on the basis of a signal transmitted from the input apparatus 12. The position at which each virtual object is disposed is determined, for example, as three-dimensional coordinates in the virtual space at which the virtual object is disposed. It is to be noted that the direction in which the virtual object is disposed is determined such that the normal of the surface of the virtual object to which a texture image is pasted faces the direction of the base point. Information related to the determined position at which the virtual object is disposed is stored in the RAM 202 and used for processes by the virtual object disposing unit 305 and the like. Next, in S605, the virtual object disposing unit 305 disposes the virtual objects generated in S602 at the positions in the virtual space determined in S604.

Next, in S606, the image generating unit 306 generates a VR image including the object models generated in S601 and the virtual objects generated in S602 and disposed in S605 as images on the basis of the position of the base point set in S603. The generated VR image is stored in the RAM 202 and used for processes by the output unit 307 and the like. Next, in S607, the output unit 307 outputs the VR image generated in S606 to the distribution server 14. After S607, the image processing apparatus 100 brings the processes in the flowchart illustrated in FIG. 6 to an end.

Additionally, description has been given above on the assumption that the processes from S600 to S605 are sequentially executed, but this is not limitative. For example, as long as the process in S600 is executed before the processes in S601 and S602 and the process in S604 is executed before the process in S605, the processes from S600 to S605 may be executed in any order and two or more of the processes from S600 to S605 may be executed in parallel.

### <Generation Process of Virtual Object>

A flow of the generation process of the virtual object by the virtual object generating unit 302 in S602 will be described with reference to FIG. 7. FIG. 7 is a flowchart illustrating an example of the flow of the generation process of the virtual object by the virtual object generating unit 302 according to the embodiment 1. FIG. 7 is a flowchart illustrating an example of the flow of the process in S602. The following describes a case where a virtual object is generated using a virtual viewpoint image obtained by virtually imaging a background object model corresponding to a background object with a virtual camera as an example of the generation process of the virtual object. The virtual viewpoint image has been described using FIG. 4. The processes in the flowchart illustrated in FIG. 7 are executed by the virtual object generating unit 302 after the process in S601.

After S601, in S701, the virtual object generating unit 302 determines the position and the orientation of a virtual camera capable of imaging an object model corresponding to a real object of interest such as the object 403 on the basis of a signal from the input apparatus 12. In the present embodiment, description will be given on the assumption that an operator designates the position of an object model corresponding to an object of interest in a virtual space using the input apparatus 12 as described above, but the method for determining the position and the orientation of a virtual camera is not limited to this. For example, the virtual object generating unit 302 may determine the position and the orientation of the virtual camera by reading out a file, data, or the like including information related to the position such as a three-dimensional coordinate value in advance from the ROM 203.

Next, in S702, the virtual object generating unit 302 disposes the virtual camera having the position and the orientation determined in S701 and generates a virtual viewpoint image by virtually imaging the object model corresponding to the object of interest with the virtual camera. Next, in S703, the virtual object generating unit 302 generates a virtual object by pasting the virtual viewpoint image generated in S702 to a shape such as a panel shape represented using a polygon mesh or the like of the virtual object. Here, the virtual object generating unit 302 may paste an image obtained by masking a predetermined image region in the virtual viewpoint image to the shape of the virtual object. The predetermined image region is, for example, an image region or the like including information that is unrelated to the intention of the imaging subject such as a baseball game. The predetermined image region is an image region including information that is not appropriate for disposition near the base point.

In addition, the virtual object generating unit 302 may paste an image obtained by clipping only a predetermined image region in the virtual viewpoint image to the shape of the virtual object. In addition, the virtual object generating unit 302 may paste an image obtained by joining two or more images obtained by clipping two or more image regions in the virtual viewpoint image to the shape of the virtual object. In addition, the virtual object generating unit 302 may paste an image obtained by changing the image size, the tint, or the like of the virtual viewpoint image to the shape of the virtual object. In addition, the virtual object generating unit 302 may paste an image obtained by changing the transparency of the virtual viewpoint image to the shape of the virtual object. Even in a case where a virtual object is disposed, the image is pasted to the shape of the virtual object and a representation of an object in the back occluded by the virtual object in a view from the base point is hereby recognizable visually. After S703, the virtual object generating unit 302 brings the processes in the flowchart illustrated in FIG. 7, that is, the process in S602 to an end.

As described above, the image processing apparatus 100 is configured to generate an object model corresponding to a real object using multi-viewpoint images and generate a virtual object on the basis of the generated object model or the multi-viewpoint images. Furthermore, the image processing apparatus 100 is configured to dispose the generated virtual object near a base point and generate a VR image corresponding to a view from the base point in a state in which the virtual object is disposed. The image processing apparatus 100 configured in this way allows a VR image to be generated that may represent a representation of an object in high definition. The representation of the object is difficult to visually recognize through clipping from the VR image because of the presence or the like at a position far from the base point. As a result, a user may clearly watch the representation of the object displayed on the user terminal 15.

### [Modification Examples of Embodiment 1]

In the embodiment 1, as an example, the aspect in which the image processing apparatus 100 generates an object model has been described, but the image processing apparatus 100 may be configured to obtain an object model generated by an external apparatus not illustrated in FIGS. 1A and B. In addition, in the embodiment 1, as an example, the aspect in which the image processing apparatus 100 generates an image such as a virtual viewpoint image to be pasted to a virtual object as a texture image has been described, but this is not limitative. For example, the image processing apparatus 100 may be configured to obtain a texture image generated by an external apparatus not illustrated in FIGS. 1A and B and paste the texture image to a virtual object.

In addition, in the embodiment 1, as an example, the aspect in which the image processing apparatus 100 pastes a virtual viewpoint image and so on, as a texture image to a virtual object has been described, but this is not limitative. For example, the image processing apparatus 100 may be configured to obtain a virtual object to which an external apparatus not illustrated in FIGS. 1A and B pastes a texture image, and dispose the obtained virtual object at a determined position.

In addition, in the embodiment 1, as an example, the aspect in which one texture image is pasted to one virtual object has been described, but a plurality of texture images may be pasted to one virtual object. Specifically, for example, a plurality of images obtained by clipping a plurality of image regions from one virtual viewpoint image, a plurality of images clipped from one captured image, or a combination thereof may be pasted to the shape of a virtual object while the paste positions are changed. In addition, for example, a plurality of images clipped from a plurality of captured images included in a plurality of virtual viewpoint images or multi-viewpoint images obtained by a plurality of virtual cameras or a combination thereof may be pasted to the shape of a virtual object while the paste positions are changed. According to such a configuration, for example, in a case where there is a plurality of objects of interest, the user terminal 15 may generate a VR image that may show representations of the plurality of objects at the same time.

In addition, in the embodiment 1, as an example, the aspect in which one virtual object is disposed in a virtual space has been described, but a plurality of virtual objects may be disposed in the virtual space. In this case, texture images different from each other or the identical texture images may be pasted to the respective virtual objects. Pasting texture images different from each other to the respective virtual objects allows, for example, in a case where there is a plurality of objects of interest, the respective virtual objects to be disposed in accordance with the positional relationship between the plurality of objects. In addition, pasting the identical texture images to the respective virtual objects allows a VR image to be generated in which a representation of an object of interest is displayed without fail, for example, even if a user changes the viewing direction of the image displayed on the user terminal 15.

In addition, in the embodiment 1, as an example, the aspect in which one VR image is generated for a base point has been described, but a plurality of VR images different from each other, for example, in resolution or image size may be generated for one base point. According to such a configuration, a user may select a VR image distributed from the distribution server 14 by taking into consideration the drawing process capability of the user terminal 15, the state of the communication line between the distribution server 14 and the user terminal 15, the data amount at the time of the reception of the VR image, or the like.

In addition, in the embodiment 1, as an example, the aspect in which one base point is set has been described, but a plurality of base points may be set and one or more VR images may be generated for each of the plurality of set base points. According to such a configuration, a user may select a VR image corresponding to the position of a viewpoint that the user wishes the display device of the user terminal 15 to display from a plurality of VR images corresponding to a plurality of base points. Specifically, in a case where the imaging subject is a game at the ballpark, for example, a certain user allows the display device of the user terminal 15 used by the user himself or herself to display an image having the position of the catcher as a viewpoint. At this time, another user allows the display device of the user terminal 15 used by the other user himself or herself to display an image having the position of the pitcher as a viewpoint.

In addition, in the embodiment 1, in a case where the position of a base point is set before an object model is generated, the model generating unit 301 may generate an object model corresponding to a foreground object on the basis of the set position of the base point. Specifically, for example, the model generating unit 301 may skip or simplify the generation of a portion of the object model that is invisible in a case where the object model is viewed from the set position of the base point such that a highly accurate object model is generated only in a case where the object model is viewed from the position of the base point. Such a configuration allows for a reduction in the amount of calculation necessary to generate the object model corresponding to the foreground object.

In addition, in the embodiment 1, as an example, the aspect in which a VR image is generated in which an image as obtained through imaging by a monocular imaging device is displayed on the display device of the user terminal 15 has been described, but this is not limitative. Specifically, for example, the image processing apparatus 100 may generate two VR images from which two images that allow for stereoscopic vision on the display device of the user terminal 15 may be clipped. In this case, for example, the image processing apparatus 100 sets two base points that cause appropriate parallax and generates VR images corresponding to the two respective set base points. In addition, to allow for the clipping of images that allow for stereoscopic vision even if a user changes the viewing direction of an image displayed on the user terminal 15, the image processing apparatus 100 may generate a plurality of VR images corresponding to the positions obtained by rotating two base points having the center at the midpoint between the two base points.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, a VR image may be generated that allows a direction image to be generated. The direction image may represent, in high definition, an image corresponding to an object present at a position far from a base point.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-139224, filed on Aug. 20, 2024, which is hereby incorporated by reference herein in its entirety.

What is claimed is:

1. An image processing apparatus comprising:
one or more hardware processors; and
one or more memories storing one or more programs configured to be executed by the one or more hardware processors, the one or more programs including instructions for:
obtaining an object model that is generated on a basis of a plurality of captured images obtained through imaging from a plurality of positions, the object model indicating a three-dimensional shape of an object present in an imaging region;
determining a position of a virtual object in a virtual space;
obtaining texture of the virtual object;
setting a position of a base point in the virtual space; and
generating a VR image corresponding to the base point on a basis of the position of the base point, the object model, the virtual object, and the texture of the virtual object.

2. The image processing apparatus according to claim 1, wherein the one or more programs further include instructions for:
determining the position of the virtual object in the virtual space on a basis of the position of the base point.

3. The image processing apparatus according to claim 1, wherein the one or more programs further include instructions for:
determining a position near the position of the base point as the position of the virtual object in the virtual space.

4. The image processing apparatus according to claim 1, wherein the one or more programs further include instructions for:
determining the position of the virtual object in the virtual space on a basis of the position of the base point and a position of the object model.

5. The image processing apparatus according to claim 4, wherein the one or more programs further include instructions for:
determining, as the position of the virtual object in the virtual space, a position at which the object model is not occluded by the virtual object in a case where the object model is viewed from the position of the base point in a state in which the virtual object is disposed in the virtual space.

6. The image processing apparatus according to claim 1, wherein the one or more programs further include instructions for:
determining the position of the virtual object in the virtual space on a basis of an input made by a user through an input apparatus.

7. The image processing apparatus according to claim 1, wherein the one or more programs further include instructions for:
setting the position of the base point in the virtual space on a basis of an input made by a user through an input apparatus.

8. The image processing apparatus according to claim 1, wherein the one or more programs further include instructions for:
obtaining the texture of the virtual object by generating the texture on a basis of a virtual viewpoint image obtained by virtually imaging at least part of the object model with a virtual camera.

9. The image processing apparatus according to claim 1, wherein the one or more programs further include instructions for:
obtaining the texture of the virtual object by generating the texture on a basis of an image obtained by clipping an image region including a representation of at least part of the object from the plurality of captured images.

10. The image processing apparatus according to claim 1, wherein the one or more programs further include instructions for:
obtaining the object model by generating the object model on a basis of the plurality of captured images.

11. An image processing method comprising the steps of:
obtaining an object model that is generated on a basis of a plurality of captured images obtained through imaging from a plurality of positions, the object model indicating a three-dimensional shape of an object present in an imaging region;
determining a position of a virtual object in a virtual space;
obtaining texture of the virtual object;
setting a position of a base point in the virtual space; and
generating a VR image corresponding to the base point on a basis of the position of the base point, the object model, the virtual object, and the texture of the virtual object.

12. A non-transitory computer readable storage medium storing a program for causing a computer to perform a control method of controlling an image processing apparatus, the control method comprising the steps of:
obtaining an object model that is generated on a basis of a plurality of captured images obtained through imaging from a plurality of positions, the object model indicating a three-dimensional shape of an object present in an imaging region;
determining a position of a virtual object in a virtual space;
obtaining texture of the virtual object;
setting a position of a base point in the virtual space; and
generating a VR image corresponding to the base point on a basis of the position of the base point, the object model, the virtual object, and the texture of the virtual object.
